(19) United States
(12) Patent Application Publication
(10) Pub. No.: US 2008/0162384 A1
(43) Pub. Date: Jul. 3, 2008

(54) Statistical Heuristic Classification

(75) Inventors: John Kleist, Fort Collins, CO (US); David Todd Massey, Fort Collins, CO (US); William Paul Thorson, Fort Collins, CO (US)

Correspondence Address: HENSLEY KIM & HOLZER, LLC, 1660 LINCOLN STREET, SUITE 3000, DENVER, CO, 80264, US

(73) Assignee: PRIVACY NETWORKS, INC., Fort Collins, CO (US)

(21) Appl. No.: 11/617,323

(22) Filed: Dec. 28, 2006

(51) Int. Cl. G06F 15/18

(52) U.S. Cl. 706/12

(57) ABSTRACT

Heuristic classification is integrated with statistical classification to classify an input data set. Heuristic conditions or rule are assigned heuristic rule identifiers, which are inserted into the feature list of a statistical classifier. In this manner, the heuristic rule identifiers are treated as statistical features, the counts for which are incremented or flagged when an input data set satisfies the associated heuristic rule. Thereafter, the statistical classification score therefore includes the contribution of the heuristic rule in its result.

### BACKGROUND

Text classification (or document classification) can be used to automatically assign semantic categories to natural language text. For example, a text classification system can receive electronic medical documents containing descriptions of medical diagnoses and procedures and attribute the descriptions to one or more universal medical code numbers, such as diagnosis codes. These diagnosis codes can then be used by health insurance companies and workers' compensation insurance carriers to process claims in a data processing system.

Text classification techniques continue to improve, particularly with the large increase in electronic documentation resulting the widespread use of the communication networks (e.g., the Internet) and electronic data processing systems. Example text classifications techniques include heuristic classification and statistical classification. Heuristic classification tests a document against one or more predefined heuristic rules, each having a predefined weight, to determine a numerical result or score for the document. In contrast, statistical classification determines occurrence frequencies for individual text features (e.g., words and symbols) to produce a numerical result or score for the document. In each case, if a score satisfies a given classification condition, then the document may be attributed to the associated class.

In some approaches, heuristic classification and statistical classification have been executed separately on the same input document, with their separate numerical results being merely summed after completion of both the heuristic classification and statistical classification. However, merely summing these results is inaccurate and inadequate. Furthermore, existing heuristic text classification techniques generally require a predefined weighting that is statically assigned to specific heuristic conditions or rules within a classifier. Such static weighting is difficult to make accurate across many document sets.

### SUMMARY

Implementations described and claimed herein address the foregoing problems by integrating heuristic classification with statistical classification, such that a predetermined weighting of heuristic conditions or rules unnecessary. Heuristic rules are assigned heuristic rule identifiers, which are inserted into the feature list of a statistical classifier. In this manner, the heuristic rule identifiers are treated as statistical features, the counts for which are incremented or flagged when a document satisfies the associated heuristic condition. Thereafter, the statistical classification score therefore includes the contribution of the heuristic rule in its result.

In some implementations, articles of manufacture are provided as computer program products. One implementation of a computer program product provides a tangible computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example statistical classification system employing integrated heuristics.

FIG. 2 illustrates example statistical training including integrated heuristics.

FIG. 3 illustrates example statistical classification employing integrated heuristics.

FIG. 4 illustrates example operations for training a statistical classification system employing integrated heuristics.

FIG. 5 illustrates example operations for statistical classification employing integrated heuristics.

FIG. 6 illustrates an exemplary system useful in implementations of the described technology.

### DETAILED DESCRIPTIONS

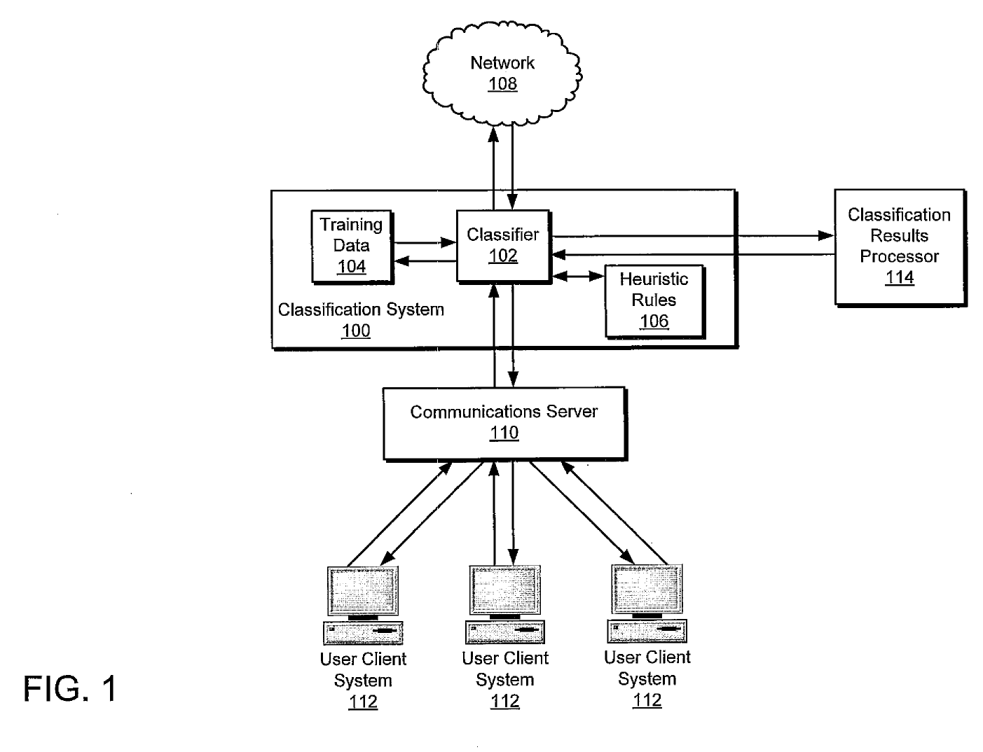

FIG. 1 illustrates an example statistical classification system 100 employing integrated heuristics. In the illustrated system 100, a classifier 102 is positioned between a communications network 108 and a communications server 110 to classify communication messages as “good” messages (e.g., legitimate email) and “bad” messages (e.g., spam). It should be understood, however, that the described technology may also be employed for classification systems not connected to a network and/or not connected to a communications server. Good messages are routed to the communications server 110 for distribution to one or more of the user client systems 112 of the intended recipient(s) (e.g., based on a destination address). Bad messages are routed to a classification results processor 114 to be inspected and/or deleted. It should be further understood that the classification system 100 may be used to classifying other data sets besides messages, such as documents, program files, digital images, audio and video files, etc.

The classification results processor 114 may include, for example, a management module to allow a user or administrator to review the contents of a quarantine data store. Through a management module, the user or administrator can make a manual determination about whether a quarantined message should be passed along (e.g., to the communications server 110 or the network 108). Other classification results processors may include without limitation a secure inbox in an email system, a secure server file system folder, another program that re-routes the message based on the classification of the message (e.g., different types of “bad” email may deserve different types of handling), etc.

Generally, statistical classification determines the frequency of features (e.g., typically words and symbols) within an input data set and compares the resulting frequency distribution from the input data set with frequency distributions of already-classified data sets to determine the probability that the input data set is in one class or another. Generally, heuristic classification employs predefined rules for determining how to classify a given data set. For example, a rule may be defined to specifying a probability that a message is spam if the message includes both the words “rolex”, “replica”, and (“offer” or “sell”). In another example, a rule may be defined to specify a probability that a message is spam if the source address of the message is received from a known spammer, as confirmed from a spammer address database.

A classifier 102 integrates heuristic classification and statistical classification by attributing a rule identifier to each heuristic rule and treating the rule identifier as a feature of the data set. Thereafter, the frequency distributions involving all detected features in an input data set are compared with frequency distributions of already-classified data sets to determine the probability that the input data set is in one class or another. This approach provides a richer feature list than known statistical classification techniques while providing a more robust and dynamically tunable heuristic classification effect. Furthermore, the integration of statistical classification and heuristic classification, as described herein, generally provides a more accurate classification system.

Initially, the classifier 102 is trained, using training data 104, to generate per-class frequency distributions pertaining to frequency counts of features detected in the data sets of the training data 104. These training data sets are each attributed to one or more classes before training. During training, the training data sets are input to the classifier 102, which tests each data set to generate a class-dependent frequency count for each detected feature. The aggregated frequency counts associated with each class are allocated to per-class frequency distributions, which are recorded in a storage medium accessible by the classification system 100. In one implementation, for example, the frequency distribution of each data set is summed with the frequency distribution of each other data set sharing the same class.

Heuristic rules 106 are defined and recorded in a storage medium accessible by the classification system, and each heuristic rule is attributed to a rule identifier. The rule identifier acts as a feature in a feature list, just as a word or symbol. As a rule tester module (not shown) of the classifier 102 detects that a heuristic rule is satisfied within a training data set, the rule tester module adds the corresponding rule identifier to the feature list, if it is not already included, and increments or flags the count associated with the rule identifier within the class associated with the input data set. In this way, a frequency count is accumulated or specified for each heuristic rule (based on the rule's identifier), just as with each word or symbol, in the training data. When training is completed, a frequency distribution for each class has been generated to include frequency counts for individual features (e.g., words, symbols, audio characteristics, video characteristics, image characteristics, and rule identifiers of heuristic rules) occurring within the training data.

During classification, the classifier 102 receives an input data set (not shown), such as via a network 108, a communications server 110 (e.g., an email server), or some other input mechanism. The frequency tester module discussed with regard to the training stage (or a separate frequency tester module) tests the input data set to generate a frequency count for each detected feature within the input data set, including without limitation words, symbols, audio characteristics, video characteristics, image characteristics, etc. The resulting frequency distribution is statistically evaluated relative to the frequency distributions of each class (e.g., determined during the training stage) to classify the input data set in one of the classes. In one implementation, a statistical algorithm, described later, is used to classify the input data set, although other statistical classification algorithms may be employed, including without limitation Graham's Bayesian Combination, Burton's Bayesian Combination, Robinson's Geometric Mean Test, Fisher-Robinson's Inverse Chi Square Test, etc.

In some implementations, a user may accept, reject, or correct the classification. If rejected, the classification may be changed to suggest a next-best-fit class (e.g., the class with the highest probability of containing the input data set as a member). The classified frequency distribution may then be fed back into or combined with the training data 104 to improve the richness of the per-class frequency distributions for subsequent classification operations. For example, the frequency counts generated from the current classification operation may be added into the frequency distribution of the resulting class.

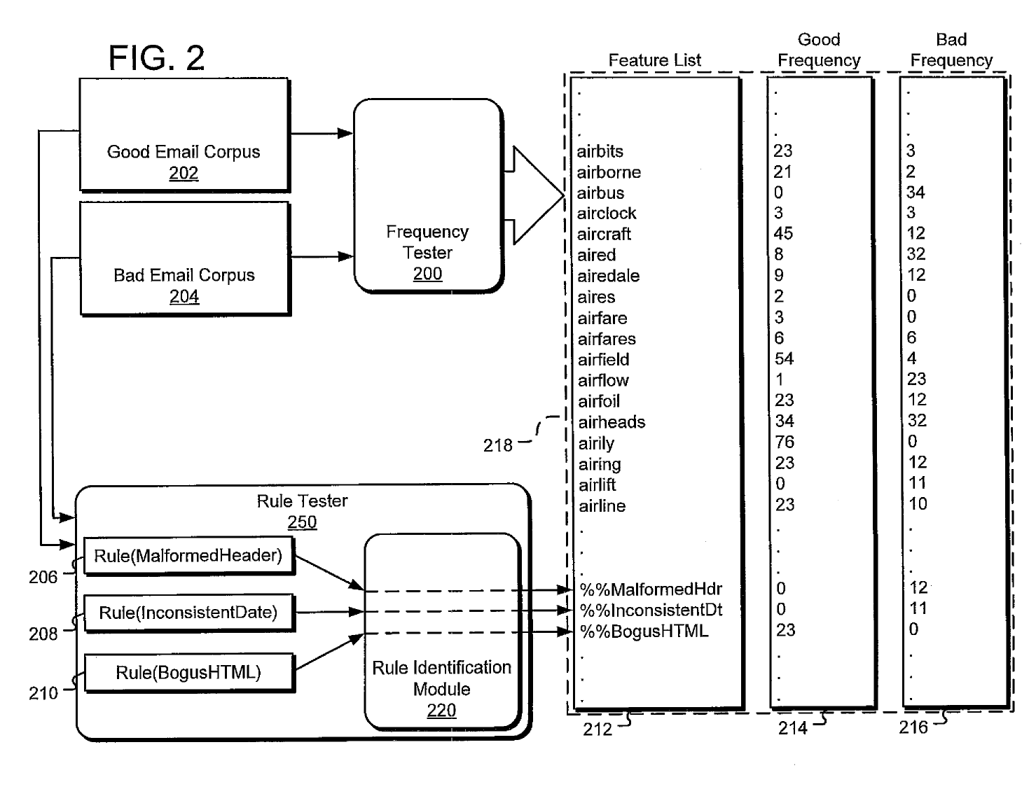

FIG. 2 illustrates example statistical training including integrated heuristics. Training data 202 and 204 represent groups of previously-classified individual data sets (e.g., email messages). The training data 202 and 204 may be provided from a number of different sources. For example, the training data 202 and 204 may be generated by a developer, a user, etc. based on the known classification of the individual training data sets within each corpus. For example, the developer may generate a large number of previously classified email messages (e.g., individual data sets), which may have been classified manually or through some other classification process.

During the training stage, a frequency tester 200 receives training data 202 attributed to a first class (e.g., a “good email corpus”) and training data 204 attributed to a second class (e.g., a “bad email corpus”). The frequency tester 200 counts occurrences of features (e.g., words, symbols, audio characteristics, video characteristics, image characteristics, etc.) in each training data set and applies these counts to a frequency table associated with the class of the individual training data set (e.g., the good message frequency table 214 and the bad message frequency table 216). The frequency tester 200, for example, can parse a training data set and identify distinct words and symbols. If a new feature (e.g., a word or symbol not previously added to the feature list 212) is detected, then the new feature is added to the feature list and its count is incremented or flagged in the per-class frequency table associated with class of the current training data set. If the feature is already in the feature list, then the count is incremented or flagged in the per-class frequency table associated with class of the current training data set.

During the training stage, a rule tester 250 also receives the training data 202 attributed to a first class (e.g., a “good email corpus”) and training data 204 attributed to a second class (e.g., a “bad email corpus”). Heuristic rules 206, 208, and 210 are defined, although it should be understood that the number of heuristic rules is not limited to three and that any number of heuristic rules may be implemented in a classification system of the described technology. A rule identification module 220 attributes each heuristic rule to a rule identifier, which acts as a feature for the feature list, in addition to features such as words and symbols. The rule identification module 220 (or the rule tester 250) may also generate the rule identifier in such a way as to make it unique over the set of expected other features (e.g., such as words and symbols expected to be found in training data sets and input data sets). Hence, in the illustrated example, a rule identifier format including an abbreviated mnemonic with a “%%” prefix is used, although other rule identifier formats may be employed.

An example heuristic rule 206 named “Malformed Header” may detect a malformed header of an email message using program code to evaluate the header fields of the message against known header formats. If the email message header is detected as being malformed, then the frequency count associated with a rule identifier “%% MalformedHdr” is incremented or flagged in the frequency table attributed to the class of the training data set currently being tested. Another example heuristic rule 208 named “Inconsistent Date” may compare the send date/time of the message (e.g., read from the message header) with the current date/time. If the email message's send date/time is before the current date/time (at least outside an acceptable window), then the frequency count a rule identifier “%% InconsistentDt” is incremented in the frequency table attributed to the class of the training data set currently being tested. Yet another example heuristic rule 210 named “Bogus HTML” may compare HTML text found in the message body with known HTML grammars and formats. If the email message contains text that is detected to be HTML but does not satisfy known HTML grammars and formats, then the frequency count a rule identifier “%% BogusHTML” is incremented or flagged in the frequency table attributed to the class of the training data set currently being tested.

Heuristic rules may also be associated with distinct portions or characteristics of a data set. For example, a heuristic rule may address a specified portion of a message header (e.g., the source address, the destination address, a message type field, etc.), a data set characteristic (e.g., size), an author, and other specified portions or characteristics of a data set. Other heuristic rules may be defined and evaluated for any given training data set, such as message text is disguised using base64 encoding, MIME character set is an unknown ISO character set, character set indicates a foreign language, the relay identified in the HELO command does not match the relay specified by reverse DNS, the relay identified in the HELO command specifies a suspicious host name, the message includes one or more HTML images with only 0-400 bytes of text, etc.

As described above with regard to the frequency tester 200, the rule tester 250 also counts the occurrence of features within training data sets, specifically heuristic features in this case. The rule tester 250, for example, can parse a training data set and determine whether a heuristic rule is satisfied by the content (e.g., contained text, header information, etc.) or characteristics (e.g., size, creation date, etc.) of the data set. If a new heuristic feature (e.g., associated with a rule identifier not previously added to the feature list 212) is detected, then the rule identifier of the new heuristic feature is added to the feature list and its count is incremented or flagged in the per-class frequency table associated with class of the current training data set. If the rule identifier of the heuristic feature is already in the feature list, then the count is incremented or flagged in the per-class frequency table associated with class of the current training data set.

The training operation results in one or more per-class frequency tables with frequency counts corresponding to features in a feature list. Note: It should be understood that a frequency count may represent a number of times a feature was detected, including the number of times a heuristic rule was satisfied, although the frequency count may also represent a binary flag indicating whether a feature was detected, including whether a heuristic rule was satisfied. The resulting statistical training data 218, including the frequency table(s) and frequency list generated from the training operation, is stored in one or more storage media for use in a subsequent classification operation.

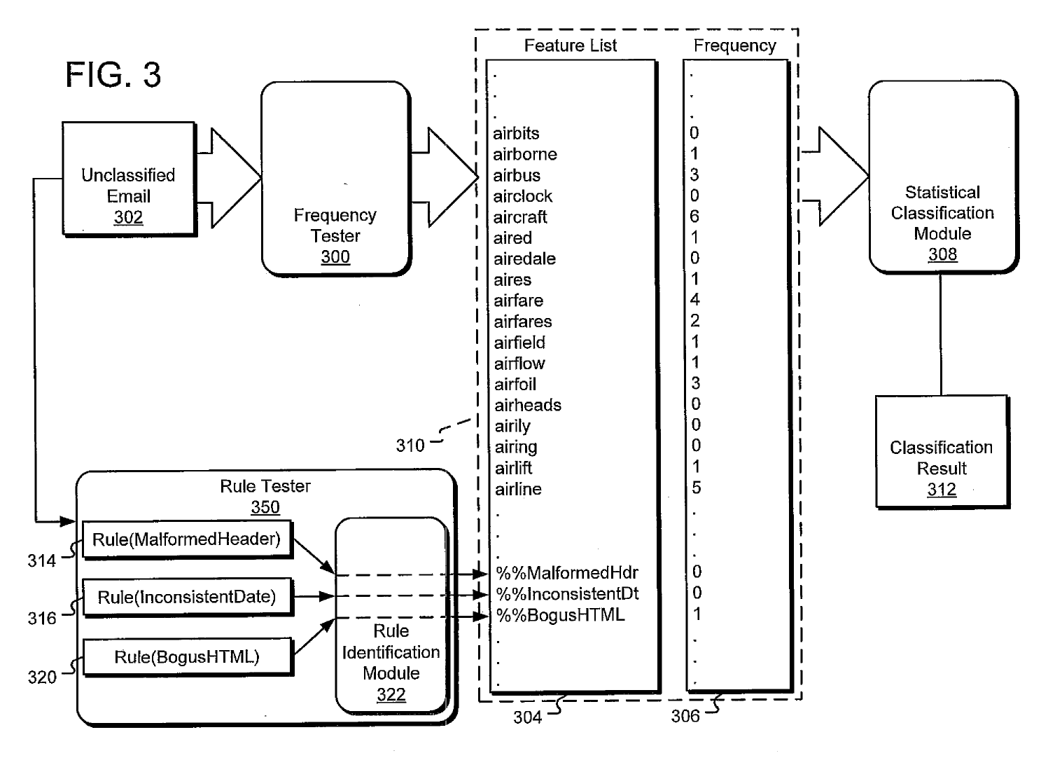

FIG. 3 illustrates example statistical classification employing integrated heuristics. A frequency tester 300, which may be the same frequency tester used during the training operation or a separate frequency tester, receives an unclassified data set 302 (e.g., an unclassified email message). Heuristic rules 314, 316, and 318 have been defined, although it should be understood that the number of heuristic rules is not limited to three and that any number of heuristic rules may be implemented in a classification system of the described technology. A rule identification module 322 attributes each heuristic rule to a rule identifier, which acts as a feature for the rule tester 350. The rule identification module 322 (or the rule tester 350) may also generate the rule identifier in an attempt to make the rule identifier unique over the set of expected other features (e.g., such as words and symbols expected to be found in training data sets and input data sets).

The frequency tester 300 counts occurrences of features (e.g., words, symbols, audio characteristics, video characteristics, image characteristics, etc.) in the input data set 302 and applies these counts to a frequency table associated with the input data set 302. The frequency tester 300, for example, can parse the input data set 302 and identify distinct words and symbols. If a new feature (e.g., a feature not previously added to the feature list 304) is detected, then the new feature is added to the feature list 304 and its count is incremented or flagged in the frequency table 306 associated with the input data set 302. If the feature is already in the feature list 304, then the count is incremented or flagged in the class frequency table 306 associated with the input data set 302.

The rule tester 350 also counts occurrences of heuristic features in the input data set 302. These occurrences are identified in the frequency table 306 associated with the input data set 302, in correspondence with the appropriate rule identifier in the feature list 304. The rule tester 350, for example, can parse a training data set and determine whether a heuristic rule is satisfied by the content (e.g., contained text, header information, etc.) or characteristics (e.g., size, creation date, etc.) of the data set. If a new heuristic feature (e.g., a heuristic feature not previously added to the feature list 304) is detected, then a rule identifier of the new heuristic feature is added to the feature list and its count is incremented or flagged in the frequency table associated with the current input data set. If the rule identifier of the heuristic feature is already in the feature list, then the count is incremented or flagged in the frequency table associated with the current input data set.

The statistical classification module 308 receives the statistical data 310 from the feature list 304 and the frequency table 306 and determines a classification result 312. In one implementation, a statistical algorithm is employed to classify the input data set 302. The probability that the input data set 302 is in a given class j is defined as Pⱼ, which may be computed as:

$${P}_{j} = {e}^{( {\sum }_{i = 1}^{N} {W}_{i} ln ( \frac{{F}_{ij}}{T} ) )}$$

where N represents the number of features in the input data set, Wᵢ represents the number of occurrences of a feature i in the input data set (i.e., the feature count associated with a feature i in the input data set), Fᵢⱼ represents the number of occurrences of a feature i in the frequency distribution of class j, as determined from the training data, and T represents the total number of features occurring in the training data (e.g., the number of features listed in the feature list).

The class having the highest probability is selected as the classification result 312 attributed to the input data set 302. It should be understood, however, that the classification result 312 may also be altered by the user or some other mechanism. For example, the user may recognize the data set as a “good” email message even though the statistical classification module 308 found a higher probability that the data set was a “bad” email address. As such, the initial classification result may be changed after it is first generated by the statistical classification module 308. The frequency distribution (e.g., the frequency table 306) of the statistical data 310 determined for the input data set 302 may be added to the appropriate per-class frequency distribution in the training data, based on the final classification result 312 to strengthen the accuracy of the training data. In this manner, statically-assigned weighting of heuristic rules is unnecessary as the contribution of a given rule to a given class is influenced by the training data and updates thereto by subsequent classifications.

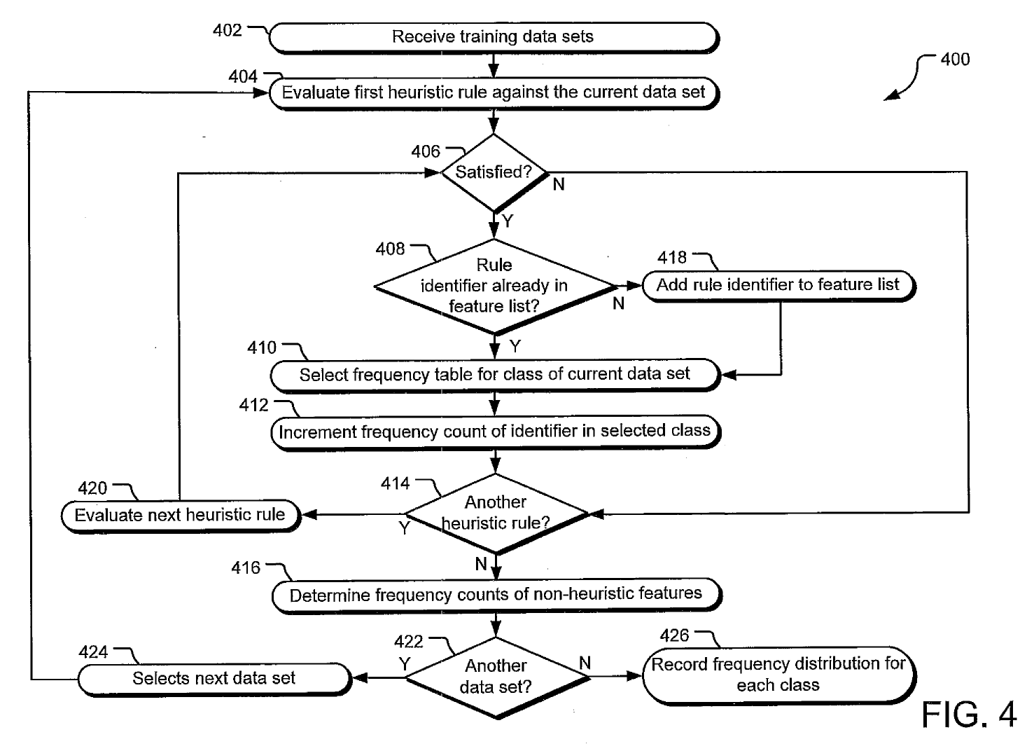

FIG. 4 illustrates example operations 400 for training a statistical classification system employing integrated heuristics. A receiving operation 402 receives training data including one or more already-classified training data sets. For example, each training data set may represent without limitation a word processing document, an email message, a spreadsheet, an HTML document, program source code, form data, etc. Each training data set has been previously attributed to a class in order to assist in the generation of statistical data for individual classes. Subsequent operations of the training stage work to develop the per-class frequency distributions used to classify input data sets during a classification stage.

An evaluation operation 404 selects a current data set from the training data sets, selects a first heuristic rule, and evaluates the selected heuristic rule against the current data set. The evaluation operation 404 may, for example, execute program code to determine whether contents (e.g., text within the data set) or context (e.g., date of receipt or size) of the current training data set satisfies the selected heuristic rule. A decision operation 406 determines whether the heuristic rule is satisfied by the current training data set.

If the heuristic rule is not determined to be satisfied in the decision operation 406, processing proceeds to a decision operation 414, which determines if another heuristic rule exists to be evaluated. However, if the heuristic rule is determined to be satisfied by the decision operation 406, another decision operation 408 determines whether the rule identifier associated with the heuristic rule is already in the feature list. If not, an addition operation 418 adds the rule identifier to the feature list.

After operation 408 or 418, a selection operation 410 selects a frequency table for the class of the current training data set. For example, if the current training data set is considered a “good” email message, the frequency table associated with “good” email messages is selected. An incrementing operation 412 increments or flags the frequency count of the appropriate rule identifier in the frequency table for the selected class.

The decision operation 414 determines whether another heuristic rule exists. If so, the next heuristic rule is evaluated in an evaluation operation 420, and the result is determined in the decision operation 406. These operations therefore result in an execution loop through the heuristic rules available to the classification system. Although the illustrated operations test for the satisfaction of the heuristic rule once per training data set, it should be understood that, depending on the heuristic rule, a classification system may test an individual heuristic rule multiple times per training data set, including without limitation for each parsed token, for each paragraph, etc. For example, an additional execution loop may be added for each parsed token, each paragraph, etc. If a heuristic rule is satisfied multiple times within the same data set, the count associated with the rule identifier of that heuristic rule may be incremented each time.

A frequency test operation 416 determines the frequency counts of non-heuristic features of the current training data set. It should be understood that the determinations of heuristic and non-heuristic feature frequency counts may be merged into shared execution loops in some implementations. The illustrated implementation is provided in an effort to clarify operation of an example system, although other implementations may be employed.

A decision operation 422 determines whether another training data set exists for use in the training stage. If so, a selection operation 424 selects a next data set as the current data set and processing proceeds to the evaluation operation 404 to initiate evaluation of this data set. Otherwise, a recording operation 426 records the frequency distributions for each class, as generated from the incrementing operation 412, in a tangible storage medium (e.g., a memory, a hard disk, etc.). The recorded frequency distributions are used in classifying input data sets in subsequent classification operations.

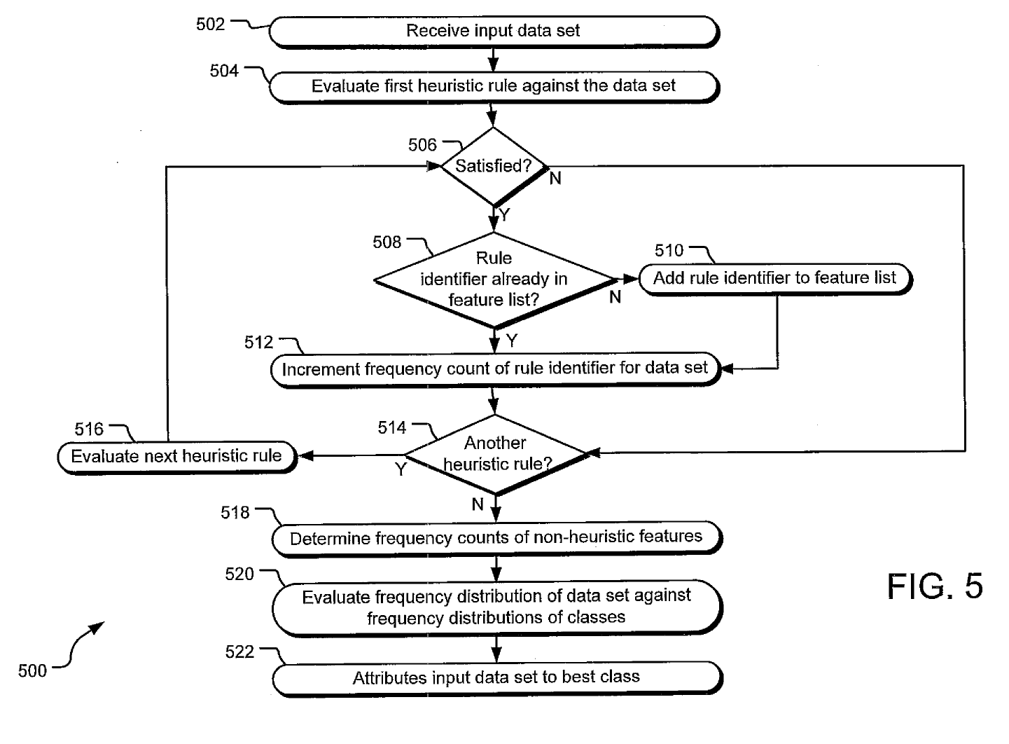

FIG. 5 illustrates example operations 500 for statistical classification employing integrated heuristics. A receiving operation 502 receives an input data set, such as a word processing document, an email message, a spreadsheet, an HTML document, program source code, form data, etc. An evaluation operation 504 selects a first heuristic rule and evaluates the selected heuristic rule against the current data set. The evaluation operation 504 may, for example, execute program code to determine whether contents (e.g., text within the data set) or context (e.g., date of receipt or size) of the input data set satisfies the selected heuristic rule. A decision operation 506 determines whether the heuristic rule is satisfied by the input data set.

If the heuristic rule is not determined to be satisfied in the decision operation 506, processing proceeds to a decision operation 514, which determines if another heuristic rule exists to be evaluated. However, if the heuristic rule is determined to be satisfied by the decision operation 506, another decision operation 508 determines whether the rule identifier associated with the heuristic rule is already in the feature list. If not, an addition operation 510 adds the rule identifier to the feature list. After operation 508 or 510, an incrementing operation 512 increments or flags the frequency count of the appropriate rule identifier in the frequency table for the selected class.

The decision operation 514 determines whether another heuristic rule exists. If so, the next heuristic rule is evaluated in an evaluation operation 516, and the result is determined in the decision operation 506. These operations therefore result in an execution loop through the heuristic rules available to the classification system. Although the illustrated operations test for the satisfaction of the heuristic rule once per input data set, it should be understood that, depending on the heuristic rule, a classification system may test an individual heuristic rule multiple times per input data set, including without limitation for each parsed token, for each paragraph, etc. For example, an additional execution loop may be added for each parsed token, each paragraph, etc. If a heuristic rule is satisfied multiple times within the same data set, the count associated with the rule identifier of that heuristic rule may be incremented each time.

A frequency test operation 518 determines the frequency counts of non-heuristic features of the input data set. It should be understood that the determinations of heuristic and non-heuristic feature frequency counts may be merged into shared execution loops in some implementations. The illustrated implementation is provided in an effort to clarify operation of an example system, although other implementations may be employed.

An evaluation operation 520 evaluates the frequency distribution of the input data set against the per-class frequency distributions of the training data. A previously discussed statistical algorithm may be used for such evaluation, although other implementations may employ other algorithms without limitation Graham's Bayesian Combination, Burton's Bayesian Combination, Robinson's Geometric Mean Test, Fisher-Robinson's Inverse Chi Square Test, etc. A classification operation 522 attributes the input data set to the most appropriate class. For example, using the previously described statistical algorithm, the class j exhibiting the highest probability Pⱼ of including the input data set is selected and the input data set is classified as a member of that class j. As previously discussed, the initial classification result may be altered, such as by user intervention, etc. The frequency distribution generated from the frequency operation 518 may then added to the frequency distribution of the resulting class in the training data to increase the accuracy of the training data.

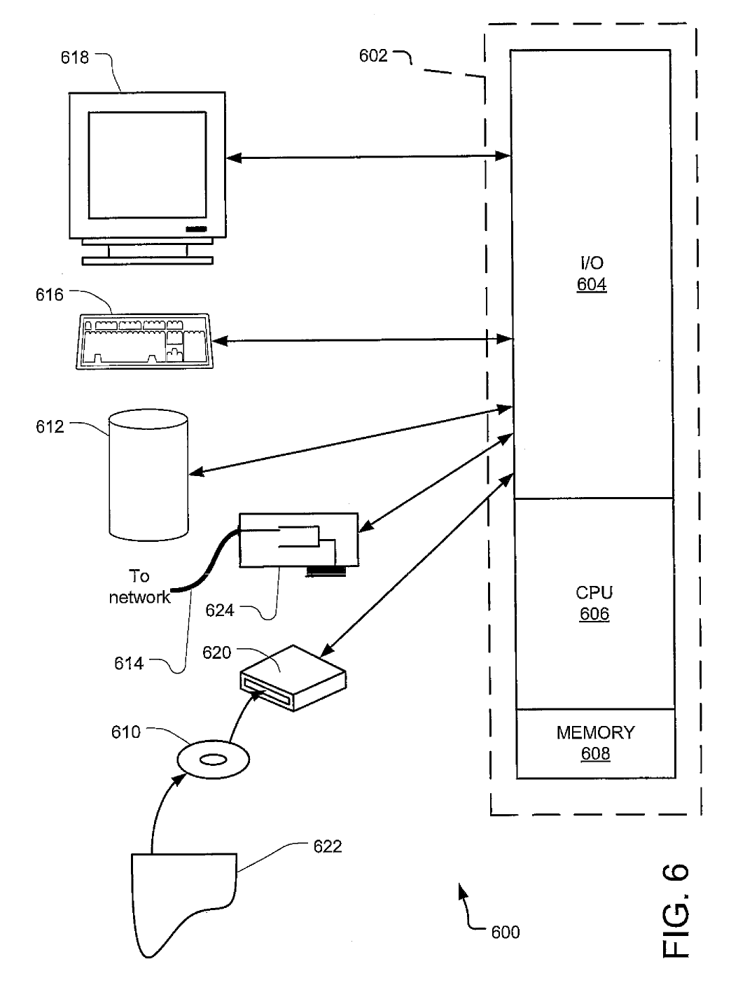

FIG. 6 illustrates an exemplary system useful in implementations of the described technology. A general purpose computer system 600 is capable of executing a computer program product to execute a computer process. Data and program files may be input to the computer system 600, which reads the files and executes the programs therein. Some of the elements of a general purpose computer system 600 are shown in FIG. 6 wherein a processor 602 is shown having an input/output (I/O) section 604, a Central Processing Unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a distributed computer, or any other type of computer. The described technology is optionally implemented in software devices loaded in memory 608, stored on a configured DVD/CD-ROM 610 or storage unit 612, and/or communicated via a wired or wireless network link 614 on a carrier signal, thereby transforming the computer system 600 in FIG. 6 to a special purpose machine for implementing the described operations.

The I/O section 604 is connected to one or more user-interface devices (e.g., a keyboard 616 and a display unit 618), a disk storage unit 612, and a disk drive unit 620. Generally, in contemporary systems, the disk drive unit 620 is a DVD/CD-ROM drive unit capable of reading the DVD/CD-ROM medium 610, which typically contains programs and data 622. Computer program products containing mechanisms to effectuate the systems and methods in accordance with the described technology may reside in the memory section 604, on a disk storage unit 612, or on the DVD/CD-ROM medium 610 of such a system 600. Alternatively, a disk drive unit 620 may be replaced or supplemented by a floppy drive unit, a tape drive unit, or other storage medium drive unit. The network adapter 624 is capable of connecting the computer system to a network via the network link 614, through which the computer system can receive instructions and data embodied in a carrier wave. Examples of such systems include personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 600 is connected (by wired connection or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are exemplary and other means of and communications devices for establishing a communications link between the computers may be used.

In an exemplary implementation, frequency tester modules, rule tester modules, statistical classification modules, rule identification modules, and other modules may be incorporated as part of the operating system, application programs, or other program modules. Training data, heuristic rules, rule identifiers, statistical data, and other data may be stored as program data.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method comprising:
determining training data frequency counts specifying occurrences of features in each of one or more training data sets, each training data set being attributed to a class, the training data frequency counts including a heuristic frequency count specifying satisfaction of a heuristic rule by the one or more training data sets;
allocating the determined training data frequency counts into per-class frequency distributions corresponding to the class of each training data set;
recording the per-class frequency distributions in a tangible storage medium for use in classification of an input data set.

2. The method of claim 1 wherein the heuristic frequency count specifies a number of times the heuristic rule is satisfied within the one or more training data sets.

3. The method of claim 1 wherein the heuristic frequency count specifies a binary flag indicating that a heuristic rule is satisfied within the one or more training data sets.

4. The method of claim 1 further comprising:
classifying the input data set based on the per-class frequency distributions.

5. The method of claim 1 further comprising:
determining frequency counts specifying occurrences of features in the input data set, the frequency counts including a heuristic frequency count specifying satisfaction of a heuristic rule by the input data set.

6. The method of claim 1 further comprising:
determining a frequency distribution of the input data set, wherein the frequency distribution includes at least one heuristic frequency count;
identifying a class of the input data set based on the per-class frequency distributions and the frequency distribution of the input data set.
combining the frequency distribution of the input data set with the per-class frequency distribution associated with the class of the input data set.

7. The method of claim 6 wherein the classifying operation comprises:
determining a probability that the input data set is a member of one of the classes, based on the per-class frequency distributions.

8. The method of claim 1 wherein the heuristic rule is directed to a specified portion of each of the one or more training data sets.

9. The method of claim 1 wherein the heuristic rule is directed to a specified characteristic of each of the one or more training data sets.

10. A tangible computer-readable medium having computer-executable instructions for performing a computer process, the computer process comprising:
determining training data frequency counts specifying occurrences of features in each of one or more training data sets, each training data set being attributed to a class, the training data frequency counts including a heuristic frequency count specifying satisfaction of a heuristic rule by the one or more training data sets;
allocating the determined training data frequency counts into per-class frequency distributions corresponding to the class of each training data set;
recording the per-class frequency distributions in a tangible storage medium.

11. The tangible computer-readable medium of claim 10 wherein the heuristic frequency count specifies a number of times the heuristic rule is satisfied within the one or more training data sets.

12. The tangible computer-readable medium of claim 10 wherein the heuristic frequency count specifies a binary flag indicating that a heuristic rule is satisfied within the one or more training data sets.

13. The tangible computer-readable medium of claim 10 wherein the computer process further comprises:
classifying an input data set based on the per-class frequency distributions.

14. The tangible computer-readable medium of claim 10 wherein the computer process further comprises:
determining frequency counts specifying occurrences of features in an input data set, the frequency counts including a heuristic frequency count specifying satisfaction of a heuristic rule by the input data set.

15. The tangible computer-readable medium of claim 10 wherein the computer process further comprises:
determining a frequency distribution of an input data set, wherein the frequency distribution includes at least one heuristic frequency count;
identifying a class of the input data set based on the per-class frequency distributions and the frequency distribution of the input data set.
combining the frequency distribution of the input data set with the per-class frequency distribution associated with the class of the input data set.

16. The tangible computer-readable medium of claim 15 wherein the classifying operation comprises:
determining a probability that the input data set is a member of one of the classes, based on the per-class frequency distributions.

17. The tangible computer-readable medium of claim 10 wherein the heuristic rule is directed to a specified portion of each of the one or more training data sets.

18. The tangible computer-readable medium of claim 10 wherein the heuristic rule is directed to a specified characteristic of each of the one or more training data sets.

19. A method comprising:
determining frequency counts specifying occurrences of features in an input data set, the frequency counts including a heuristic frequency count specifying satisfaction of a heuristic rule by the input data set;
evaluating a distribution of the frequency counts associated with the input data set with per-class distributions of frequency counts associated with a plurality of classes;
classifying an input data set based on the per-class frequency distributions and the distribution of the frequency counts associated with the input data set to identify a class of the input data set.

20. The method of claim 19 wherein the heuristic frequency count specifies a number of times the heuristic rule is satisfied within the input data set.

21. The method of claim 19 wherein the heuristic frequency count specifies a binary flag indicating that heuristic rule is satisfied within the input data set.

22. The method of claim 19 wherein the classifying operation identifies a class of the input data set and further comprising:
combining the frequency distribution associated with the input data set with the per-class frequency distribution associated with the class of the input data set.

23. The method of claim 19 wherein the classifying operation comprises:
determining a probability that the input data set is a member of one of the classes, based on the per-class frequency distributions.

24. The method of claim 19 wherein the heuristic rule is directed to a specified portion of each of the input data set.

25. The method of claim 19 wherein the heuristic rule is directed to a specified characteristic of each of the input data set.

26. A tangible computer-readable medium having computer-executable instructions for performing a computer process, the computer process comprising:
determining frequency counts specifying occurrences of features in an input data set, the frequency counts including a heuristic frequency count specifying satisfaction of a heuristic rule by the input data set;
evaluating a distribution of the frequency counts associated with the input data set with per-class distributions of frequency counts associated with a plurality of classes;
classifying an input data set based on the per-class frequency distributions.

27. The tangible computer-readable medium of claim 26 wherein the heuristic frequency count specifies a number of times the heuristic rule is satisfied within the input data set.

28. The tangible computer-readable medium of claim 26 wherein the heuristic frequency count specifies a binary flag indicating that heuristic rule is satisfied within the input data set.

29. The tangible computer-readable medium of claim 26 wherein the classifying operation identifies a class of the input data set and the computer process further comprises:
combining the frequency distribution associated with the input data set with the per-class frequency distribution associated with the class of the input data set.

30. The tangible computer-readable medium of claim 26 wherein the classifying operation comprises:
determining a probability that the input data set is a member of one of the classes, based on the per-class frequency distributions.

31. The tangible computer-readable medium of claim 26 wherein the heuristic rule is directed to a specified portion of each of the input data set.

32. The tangible computer-readable medium of claim 26 wherein the heuristic rule is directed to a specified characteristic of each of the input data set.
